(19) United States
(12) Patent Application Publication
(10) Pub. No.: US 2026/0195323 A1
(43) Pub. Date: Jul. 9, 2026

(54) SYSTEMS, APPARATUSES, METHODS, AND NON-TRANSITORY COMPUTER-READABLE STORAGE DEVICES FOR INFORMATION RETRIEVAL

(71) Applicant: Royal Bank of Canada, Toronto (CA)

(72) Inventors: Parishad BEHNAMGHADER, Montreal (CA); Mohammad Amin Shabani, Vancouver (CA); Jiawei He, Vancouver (CA); Leonid Sigal, Vancouver (CA); Siqi Liu, Vancouver (CA)

(21) Appl. No.: 19/429,732

(22) Filed: Dec. 22, 2025

Related U.S. Application Data
(60) Provisional application No. 63/741,612, filed on Jan. 3, 2025.

(51) Int. Cl. G06F 16/242

(52) U.S. Cl. CPC G06F 16/2438

(57) ABSTRACT

Embodiments of the present application provide a computerized method of hierarchical information retrieval amongst a corpus of higher-level text entities. The method comprises: for each of the higher-level text entity in the corpus: generating, by a lower-level neural-network-based encoder, a plurality of lower-level embeddings for a plurality of lower-level text entities within the higher-level text entity; and generating, by a higher-level neural-network-based encoder, a higher-level embedding of the higher-level text entity based on the lower-level embeddings of the plurality of the lower-level text entities; receiving a query; generating an embedding of the query; locating one or more higher-level text entities corresponding to one or more higher-level embeddings which have the highest similarities to the embedding of the query; and locating one or more lower-level text entities corresponding to one or more lower-level embeddings which have the highest similarities to the embedding of the query

### CROSS-REFERENCE TO RELATED APPLICATIONS

This application claims priority to U.S. Provisional Application No. 63/741,612, entitled “SYSTEMS, APPARATUSES, METHODS, AND NON-TRANSITORY COMPUTER-READABLE STORAGE DEVICES FOR INFORMATION RETRIEVAL”, filed Jan. 3, 2025, which is hereby incorporated by reference in its entirety.

### FIELD OF THE DISCLOSURE

The present disclosure generally relates to systems, apparatuses, methods, and non-transitory computer-readable storage media, and in particular to systems, apparatuses, methods, and non-transitory computer-readable storage media for information retrieval.

### BACKGROUND

Retrieving relevant information from a corpus in response to a query is used for various downstream tasks, including, notably, open-domain question answering (QA), where one or more answers are generated for a given query and may “refer” to relevant pieces of knowledge selected from the corpus.

Dense retrieval is a state-of-the-art (SOTA) information retrieval approach which uses text embeddings learned by neural networks to retrieve the most relevant passages. However, existing dense retrieval methods find it challenging to provide accurate and relevant information from the corpus, and may rely on the summaries of the documents, which are not always available.

There is therefore a desire for a solution that addresses at least some of the challenges of the existing methods.

### SUMMARY

According to one aspect of this disclosure, there is provided a computerized method of hierarchical information retrieval amongst a corpus of higher-level text entities. The method comprises: for each of the higher-level text entity in the corpus: generating, by a lower-level neural-network-based encoder, a plurality of lower-level embeddings respectively representing a plurality of lower-level text entities within the higher-level text entity; and generating, by a higher-level neural-network-based encoder, a higher-level embedding of the higher-level text entity based on the plurality of lower-level embeddings. The method further comprises receiving a query; generating an embedding of the query; locating one or more higher-level text entities corresponding to one or more higher-level embeddings which have the highest similarities to the embedding of the query; and locating one or more lower-level text entities corresponding to one or more lower-level embeddings which have the highest similarities to the embedding of the query.

In some embodiments, the computerized method further comprises: generating a vector co-dimensional with the plurality of lower-level embeddings of the plurality of the lower-level text entities to summarize among the plurality of lower-level embeddings; and wherein generating the higher-level embedding of the higher-level text entity comprises generating the higher-level embedding as an output corresponding to the vector.

In some embodiments, the vector is initialized randomly and jointly trained with parameters of the higher-level neural-network-based encoder.

In some embodiments, the vector remains fixed during inference for all higher-level text entities.

In some embodiments, the lower-level neural-network-based encoder, the higher-level neural-network-based encoder, and the query encoder each comprise a transformer-based model.

In some embodiments, the plurality of lower-level embeddings and the higher-level embedding have a same dimensionality.

In some embodiments, the method further comprises storing, in a database, the plurality of lower-level embeddings and the higher-level embedding generated for each higher-level text entity prior to receiving the query.

In some embodiments, locating the one or more higher-level text entities comprises computing dot-product similarities between higher-level embeddings and the query embedding and returning a first top-k set of higher-level text entities; and locating the one or more lower-level text entities comprises computing dot-product similarities between lower-level embeddings and the query embedding and returning a second top-k set of lower-level text entities.

In some embodiments, said locating one or more lower-level text entities corresponding to one or more lower-level embeddings comprises locating one or more lower-level text entities from within the located one or more higher-level text entities.

In some embodiments, the lower-level neural network encoder is trained prior to training the higher-level neural network encoder, and wherein the higher-level neural network encoder is trained using the plurality of lower-level embeddings as input.

In some embodiments, training the higher-level neural-network-based encoder comprises optimizing a contrastive loss that increases similarity between the query embedding and a positive higher-level text entity while decreasing similarity relative to one or more negative higher-level text entities.

In some embodiments, the one or more negative higher-level text entities include at least one hard negative higher-level text entity and a plurality of in-batch negative higher-level text entities.

In some embodiments, obtaining the at least one hard negative higher-level text entity comprises excluding a higher-level text entity that contains an occurrence of an answer to the query within the corresponding lower-level text entities.

According to one aspect of this disclosure, one or more processors are provided for performing the above-mentioned method.

According to one aspect of this disclosure, one or more non-transitory computer-readable storage media are provided comprising computer-executable instructions, wherein the instructions, when executed, cause one or more processors to perform the above-mentioned method.

According to one aspect of this disclosure, one or more processors are provided for performing actions comprising: for each of the higher-level text entity in the corpus: generating, by a lower-level neural-network-based encoder, a plurality of lower-level embeddings respectively representing a plurality of lower-level text entities within the higher-level text entity; and generating, by a higher-level neural-network-based encoder, a higher-level embedding of the higher-level text entity based on the plurality of lower-level embeddings. The actions further comprise receiving a query; generating an embedding of the query; locating one or more higher-level text entities corresponding to one or more higher-level embeddings which have the highest similarities to the embedding of the query; and locating one or more lower-level text entities corresponding to one or more lower-level embeddings which have the highest similarities to the embedding of the query.

In some embodiments, the actions further comprise generating a vector co-dimensional with the plurality of lower-level embeddings to summarize among the plurality of lower-level embeddings; and generating the higher-level embedding of the higher-level text entity comprises generating the higher-level embedding as an output corresponding to the vector.

In some embodiments, the plurality of lower-level embeddings and the higher-level embedding have a same dimensionality.

In some embodiments, the actions further comprise storing, in a database, the plurality of lower-level embeddings and the higher-level embedding generated for each higher-level text entity prior to receiving the query.

According to one aspect of this disclosure, one or more non-transitory computer-readable storage media comprising computer-executable instructions, wherein the instructions, when executed, cause one or more processors to perform actions comprising: for each of the higher-level text entity in the corpus: generating, by a lower-level neural-network-based encoder, a plurality of lower-level embeddings respectively representing a plurality of lower-level text entities within the higher-level text entity; and generating, by a higher-level neural-network-based encoder, a higher-level embedding of the higher-level text entity based on the plurality of lower-level embeddings. The actions further comprise receiving a query; generating an embedding of the query; locating one or more higher-level text entities corresponding to one or more higher-level embeddings which have the highest similarities to the embedding of the query; and locating one or more lower-level text entities corresponding to one or more lower-level embeddings which have the highest similarities to the embedding of the query.

In some embodiments, the actions further comprise generating a vector co-dimensional with the plurality of lower-level embeddings to summarize among the plurality of lower-level embeddings; and wherein generating the higher-level embedding of the higher-level text entity comprises generating the higher-level embedding as an output corresponding to the vector.

In some embodiments, the plurality of lower-level embeddings and the higher-level embedding have a same dimensionality.

### BRIEF DESCRIPTION OF THE DRAWINGS

These and other features of the disclosure will become more apparent from the description in which reference is made to the following appended drawings.

FIG. 1 is a computer network system according to some embodiments of this disclosure;

FIG. 2 is a block diagram of a server of the computer network system shown in FIG. 1;

FIG. 3 is a functional block diagram showing the operations of generating higher-level embeddings, according to some embodiments of this disclosure;

FIG. 4 is a functional block diagram of the computer network system shown in FIG. 1, according to some embodiments of this disclosure; and

FIG. 5 is a flowchart showing operations of a computerized method, according to some embodiments of this disclosure.

### DETAILED DESCRIPTION

Embodiments disclosed herein relate to methods, systems, and techniques for hierarchical information retrieval amongst a corpus of documents. Various embodiments disclosed herein introduce a hierarchical retrieval method that circumvents the need for document summaries by constructing higher-level embeddings (e.g., document-level embeddings) from lower-level embeddings (e.g., passage-level embeddings). The disclosed two-tiered approach first generates lower-level embeddings e.g., for individual passages within a document; and subsequently synthesizes the lower-level embeddings into a higher-level embedding (e.g. a document-level embedding). According to various embodiments, a vector co-dimensional with the lower-level embeddings is generated to summarize among the lower-level embeddings; and the higher-level embedding is generated corresponding to the vector.

For purposes of this disclosure, the terms “lower-level” and “higher-level” are used generally in relation to each other, referring to different levels of text entities in the hierarchy of a document. In some exemplary embodiments, the term “higher-level” may be used to represent “document-level” and the term “lower-level” may be used to represent “passage-level”. However, the methods, systems, and techniques disclosed herein may further be extended to more intricate text hierarchies, including sentences, paragraphs, sections, and/or the documents as a whole. In such situations, a skilled person would understand that the terms “lower-level” and “higher-level” may represent different levels of the more intricate text hierarchies.

The described methods, systems and techniques employ a neural-network-based encoder-decoder architecture, such as a transformer-based embedding models.

The disclosed hierarchical retrieval method can be used to improve the functioning of computer search systems operating over large, multi-document corpora by reducing memory bandwidth, computing costs, and latency during query-time retrieval, while increasing precision and recall for long-form documents. By computing lower-level and higher-level embeddings and using a trainable vector to synthesize higher-level representations without re-accessing lower-level content at inference, the system enables relevant higher-level entity (e.g., document) selection and location using similarity operations on compact vectors rather than full-text scanning. This yields concrete performance gains in production uses and retrieval-augmented generation, where documents greatly exceed model context windows. In deployed systems, the two-tiered retrieval (higher-level-then-lower-level) can also help reduce input/output operations, avoid repetitive tokenization, and minimize processing utilization per query, enabling higher throughput and lower tail latency under real-world traffic.

As those skilled in the art will understand, due to the complexity of the neural network engines and models, and the large amount of data for training the models, the neural-network-based methods disclosed herein cannot be manually performed and a computer system is generally required.

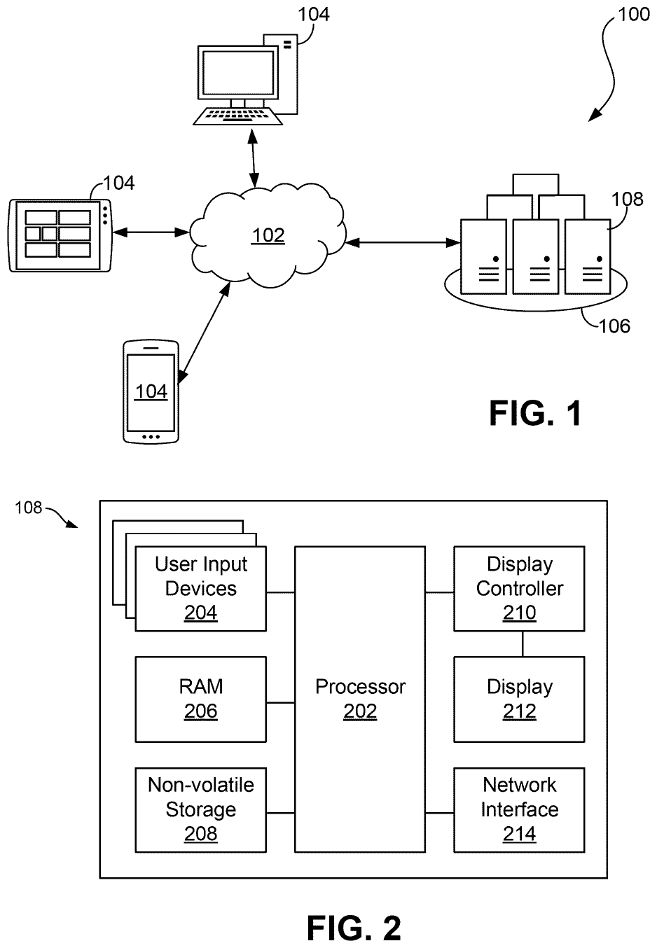

Embodiments are described below, by way of example only, with reference to FIGS. 1-6.

Referring now to FIG. 1, there is shown a computer network system 100 that comprises an example embodiment of a system for information retrieval.

As shown in FIG. 1, the computer network system 100 comprises a network 102 such as a wide area network 102 (for example, the Internet) to which various user devices 104, and data center 106 are communicatively coupled. The data center 106 comprises one or more servers 108 networked together to collectively perform various computing functions. In some implementations, the data center 106 can be hosted in a cloud service environment and/or an on-premises service environment.

In the context of information processing based on machine learning models, training a machine learning model requires large number of iterations. Thus, the training process can be conducted by one or more training devices (such as the one or more servers 108 or computer cloud). On the other hand, the trained model may be deployed in one or more execution devices (also referred to as “edge devices”) such as the user devices 104.

Referring now to FIG. 2, there is depicted an example embodiment of one of the servers 108 of the data center 106. The server 108 comprises one or more processors 202 that control the server's overall operation. The one or more processors 202 are communicatively coupled to and control several subsystems. These subsystems comprise one or more user input devices 204, which may comprise, for example, any one or more of a keyboard, mouse, touch screen, voice control, and/or the like; one or more non-transitory computer-readable storage devices or media 206 such as random access memory (“RAM”), which store computer-executable instructions or program code for execution at runtime by the processor 202; non-transitory, non-volatile, computer-readable storage devices or media 208, which store the computer-executable instructions or program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a computerized method of hierarchical information retrieval amongst a corpus of documents. Additionally or alternatively, the servers 108 may collectively perform these methods using distributed computing frameworks. While the system depicted in FIG. 2 is described specifically in respect of one of the servers 108, analogous versions of the system may also be used for the user devices 104.

The processor 202 used in the foregoing embodiments may comprise, for example, a processing unit (such as one or more processors, microprocessors, or programmable logic controllers) or one or more microcontrollers (which comprise both one or more processing units and one or more non-transitory computer readable media). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

Dense retrieval refers to the approach of using text embeddings learned by neural networks to retrieve the most relevant text chunks (e.g., passages) from a corpus. The retrieval in response to a query is based on similarities (or distances) between the embedding of the query and those of the text chunks. It can be used for various downstream tasks involving information retrieval (IR), including, notably, open-domain question answering (QA), where the model generating the answer to a given query may “refer” to relevant pieces of knowledge selected from a given corpus. A dense retrieval method utilizes an architecture based on a transformer model. The transformer-based model encodes each text chunk (e.g., passage) into an embedding (e.g., a real vector of a specific dimension). The text chunk can be limited to up to a maximum length, such as 512 tokens.

Meanwhile, the documents in the corpus, which serve as the knowledge base for a QA system are usually (much) longer. This creates a problem for dense retrieval, especially for QA systems, because the local information contained in a text chunk may be seemingly and misleadingly relevant to a query, without referring to the higher-level context, such as the entire document.

Retrieval of relevant information in long documents from a large corpus therefore poses a significant challenge for transformer-based embedding models, as short passages used for creating embeddings for retrieval lose information regarding the overall context from the document. State-of-the-art (SOTA) methods such as Dense Hierarchical Retrieval (DHR) or Hybrid Hierarchical Retrieval (HHR) attempt to address this by leveraging document summaries, including abstracts and tables of contents, for embedding documents, but they are constrained by the availability of such summaries. Moreover, the abstracts themselves can be inaccurate and/or incomplete.

According to various embodiments of this disclosure, different levels of embeddings are generated and learned for a corpus for a hierarchical retrieval, where the higher-level (e.g., document-level) embeddings are learnable functions of the lower-level (e.g., passage-level) ones. As the information contained in each lower-level text entity (e.g., passage) is assumed to be summarized into its embedding, the embeddings of all the lower-level text entities within a higher-level text entity (e.g., document) can be used to generate a higher-level embedding for the higher-level text entity (e.g., the entire document), instead of relying on the availability of document summaries. Furthermore, the method described can be generalized to more complex text hierarchies, which may be used to facilitate the location of relevant information more accurately, in contrast to some existing methods.

In the context of neural networks, text embedding, also referred to as word embedding, refers to numerical representations of text data. They are continuous vectors of numbers that capture the semantic meaning and contextual relationships of words, phrases, or entire documents in a high-dimensional space. Words and phrases with similar meanings are positioned closer to each other in the embedding space.

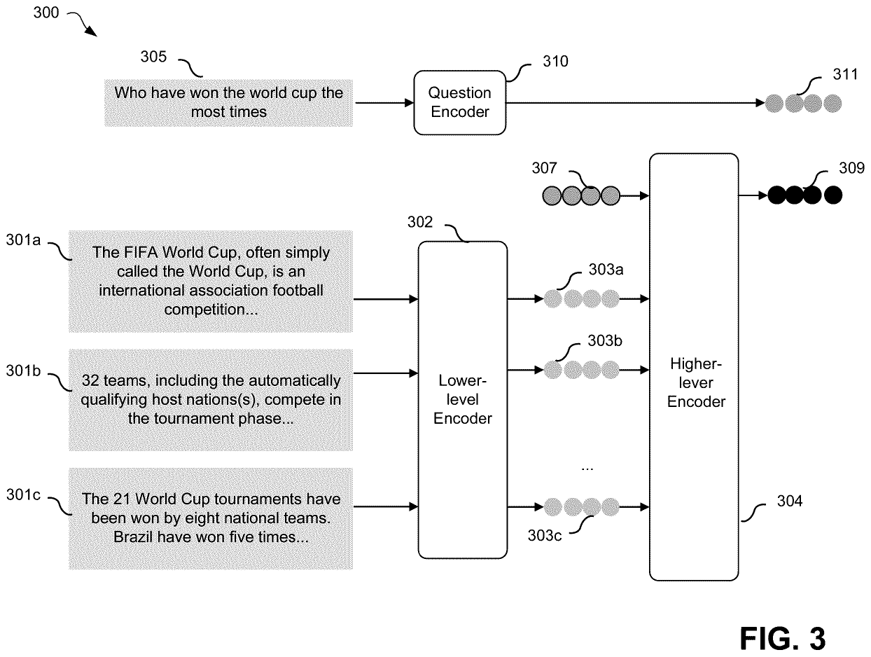

FIG. 3 is a functional block diagram 300 showing the operations of generating higher-level embeddings, according to some embodiments of this disclosure.

According to various embodiments, the computer network system 100 embodies a system that can be referred to as the Embedding-Synthesizing Hierarchical Retrieval (ESHR) system. Referring to FIG. 3, the computer network system 100 can implement a lower-level encoder (e.g., passage-level encoder, or simply, passage encoder) 302 and a higher-level encoder (e.g., document-level encoder, or simply, document encoder) 304. The computer network system 100 can further comprise a question encoder 310 for each or both encoder(s) 302, 304. Each of the lower-level encoder 302 and higher-level encoder 304 are a neural-network-based encoder. In some embodiments, the lower-level neural-network-based encoder 302, the higher-level neural-network-based encoder 304, and the query encoder 310 each comprise a transformer-based model.

As illustrated in FIG. 3, each higher-level text entity (e.g., document) comprises a plurality of lower-level text entities 301a, 301b, 301c (e.g., text chunks, or passages of the document). Each lower-level text entity 301a, 301b, 301c can be passed independently to the lower-level encoder 302 to generate corresponding embeddings 303a, 303b, 303c. In other words, each lower-level text entity 301a, 301b, and 301c is fed independently as the input to the lower-level encoder 302. A forward pass is run for each lower text entity 301a, 301b, 301c, and a corresponding embedding 303a, 303b, 303c is obtained. In some embodiments, the parameters of the lower-level encoder 302 can be shared across all lower-level text entities 301a, 301b, and 301c. It receives one lower-level text entity at a time and produces a single vector embedding for that text entity. In other words, there is no cross-entity attention or conditioning at this stage. In some embodiments, the forward passes can be executed serially or batched for efficiency, but they remain logically independent: the representation of 301a does not depend on 301b or 301c, and vice versa. The lower-level encoder 302 takes tokens of each lower-level text entity (after preprocessing) 301a, 301b, 301c, and generates a corresponding embedding 303a, 303b, 303c, representing the lower-level text entities of a higher-level text entity. In some embodiments, the embedding 303a, 303b, 303c has fixed dimensions. In some embodiments, the lower-level encoder 302 is a pretrained transformer model (e.g., bert-base-uncased).

Subsequently, the lower-level embeddings 303a, 303b, 303c serve as input to train the higher-level encoder 304 in order to generate the high-level embedding 309, as will be explained in more detail.

The query 305 received by the computer network system 100 is input to a question encoder or a query encoder 310 to generate a question embedding 311. In some embodiments of this disclosure, the question embedding 311 may have the same dimensions as the lower-level embeddings and/or higher-level embeddings.

According to the ESHR system as described, the encoder 302 on the lower-level (e.g., passage level) is trained first and the lower-level embeddings 303a, 303b, 303c are used to train the encoder 304 on the higher-level (e.g., document level). Different encoders for different levels of text entities are trained recursively, from lower to higher, using positive and negative items. The positive and negative items can be mined using question-answer pairs, specific to each level of retrieval, as will be explained in more detail.

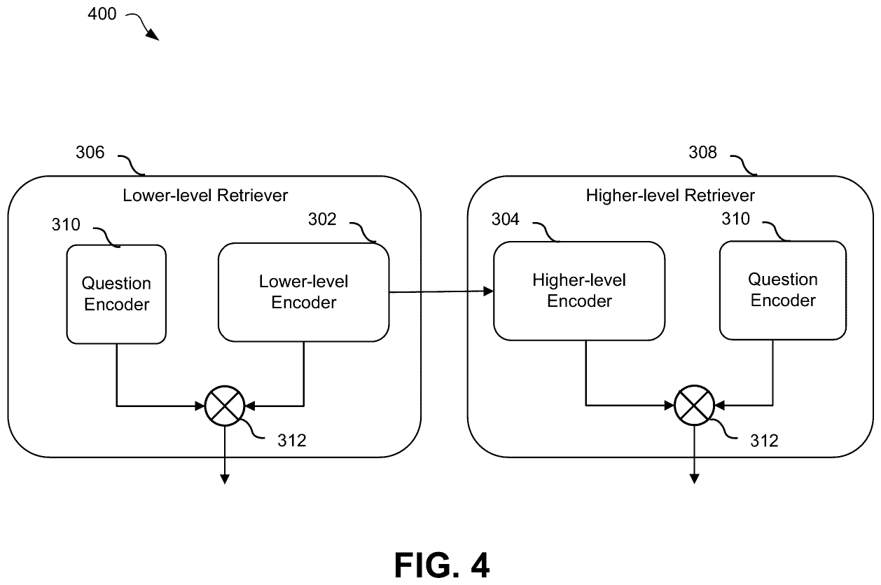

FIG. 4 is a functional block diagram 400 of the computer network system 100, according to an exemplary embodiment of this disclosure.

Referring to FIG. 4, a lower-level retriever 306 can comprise the lower-level encoder 302 and its corresponding query encoder 310; and a higher-level retriever 308 can comprise the higher-level encoder 304 and its corresponding query encoder 310. The results of the lower-level 302 or higher-level encoder 304 and its corresponding query encoder 310 can be processed through a similarity function 312 to return an ordered list of text entities. As described, embeddings generated from the lower-level encoder 302 are used to train the higher-level encoder 304. In some embodiments, dot-product similarities are computed between higher-level embeddings and the query embedding to return a first top-k set of higher-level text entities. Further, dot-product similarities are computed between lower-level embeddings and the query embedding to return a second top-k set of lower-level text entities.

In some embodiments, the higher-level embeddings 309 and the lower-level embeddings 303a, 303b, 303c can be generated offline and stored in a database, considering the large number of entities that exist in a corpus. This can occur prior to, or concurrent with, the receipt of a query by the system.

Given a query q, a lower-level retriever 306 can return an ordered list of a lower-level text entities, e.g., passages, according to their relevance to the query q. Similarly, a higher-level retriever 308 can return an ordered list of a higher-level text entities, e.g., documents, according to their relevance to the query q. For example, the top returned/retrieved passages/documents can contain the information needed to answer the query q.

For learning retrieval models for open-domain QA, let D={d₁, d₂, . . . , d_{N}} denote the corpus consisting of N higher-level text entities (e.g., documents), where each higher-level text entity dᵢ (i=1, . . . , N) is composed of Mᵢ lower-level text entities (e.g., passages),

$${d}_{i} = \{ {p}_{1}^{i} , {p}_{2}^{i} , … , {p}_{{M}_{i}}^{i} \} .$$

Let P=∪ᵢdᵢ denote all the lower-level text entities.

In dense retrieval, to measure the relevance of a lower-level text entity (e.g. passage) p to a query q, a lower-level encoder 302 (e.g., passage encoder) is used f_{P}:P→ [symbol] ^{k} to create the embedding f_{P} (p) of the lower-level text entity p, and a query encoder 310 g_{P}:q→ [symbol] ^{k} is used to create the embedding g_{P} (q) of the query q. The lower-level retriever 306 can compute a relevance of the lower-level text entities (e.g. passages) to the query as their similarity based on a chosen similarity function M_{P}: [symbol] ^{k}× [symbol] ^{k}→ [symbol] . [symbol] ^{k} is the embedding space with a dimension of k; and [symbol] is the results of the similarity function.

Similarly, the higher-level encoder (e.g., document encoder) 304, its corresponding query encoder 310, and the similarity function can be defined.

For example, to measure the relevance of a higher-level text entity (e.g., document) d to a query q, a higher-level encoder 304 (e.g., document encoder) is used f:D→ [symbol] ^{j} to create the embedding f(d) of the higher-level text entity d, and a query encoder g:q→ [symbol] ^{j} to create the embedding g(q) of the query q. The higher-level retriever 308 can compute a relevance of the higher-level text entities (e.g., documents) to the query as their similarity based on a chosen similarity function M: [symbol] ^{j}× [symbol] ^{j}→ [symbol] . [symbol] ^{j} is the embedding space with a dimension of j; and [symbol] is the results of the similarity function.

In some embodiments of this disclosure, the question encoder 310 used for the lower-level retriever 306 may be retrained for the higher-level retriever 308. For example, the query encoder can be initialized with a pre-trained transformer model (e.g., bert-base-uncased) and further trained together with the higher-level retriever 308.

In some embodiments, the embeddings of the lower-level text entities and the higher-level text entities may be of the same dimension. In other words, k=j.

According to various embodiments, the higher-level retriever 308 is constructed based on a learnable transformer-based model.

The higher-level encoder 304 f utilizes a transformer-based architecture, which uses an attention mechanism to process and learn from the lower-level embeddings 303a, 303b, 303c, allowing the model to weigh the importance of different parts of the lower-level embeddings. Let d={p₁, p₂, . . . , p_{M}} denote the higher-level text entity (e.g., document) being processed, consisting of M lower-level text entities (e.g., passages). The embedding of a lower-level text entity pᵣ is f_{P}(pᵣ)∈ [symbol] ^{k}, which is the output of the lower-level encoder f_{P} and available as input for f, r is an index of the M lower-level text entities with r=1, . . . , M.

Referring to FIG. 3, a trainable vector SUMM 307 is introduced to the input sequence, which is co-dimensional with the lower-level embeddings 303a, 303b, 303c. The vector SUMM 307 helps the higher-level encoder 304 generate a summary representation of all the lower-level text entities as the final output 309, which is the transformer's output corresponding to the vector SUMM 307. In other words, the higher-level representation (e.g., document representation) or embedding can be computed as

$$( {O}_{SUMM} , {O}_{{p}_{1}} , … , {O}_{{p}_{M}} ) = transformer ( SUMM , {f}_{P} ( {p}_{1} ) , … , {f}_{P} ( {p}_{M} ) ) , \qquad ( 1 )$$

$$f ( d ) = {O}_{SUMM}$$

where O_{SUMM} represents the transformer's output of the vector SUMM 307, and Oₚ_{₁}, . . . , Oₚ_{_{M}} represent the transformer's outputs of the lower-level embeddings.

The higher-level encoder 304, the lower-level encoder 306, and the question encoder 310 represent the transformer-based neural networks. According to some embodiments of this disclosure, the lower-level encoder 302, higher-level encoder 304, the SUMM vector 307, and the question encoder 310 are trained. In some embodiments, the lower-level encoder 302 (with its lower-level question encoder 310) can be trained first and then kept frozen; and the higher-level encoder 304 (with its higher-level question encoder 310) can be trained on the lower-level embeddings with a contrastive loss using one positive and multiple negatives. The SUMM vector 307 may be randomly initialized and trained jointly with higher-level encoder 304 to yield the higher-level embedding 309 at its output position, and the question encoder 310 for higher-level retrieval can be jointly trained with the higher-level encoder 304.

The SUMM vector 307 summarizes the lower-level embeddings by acting as a learned, attention-based pooling token inside the higher-level encoder 304. Through self-attention, it gathers and integrates information from all lower-level embeddings 303a, 303b, 303c into its own representation.

The higher-level encoder 304 receives a sequence: [SUMM, f_{P}(p₁), . . . , f_{P}(p_{M})], where each f_{P} (pᵣ) is a lower-level (passage) embedding from the lower-level encoder 302, and SUMM is a learned vector with the same dimensionality as f_{P}(pᵣ). The equal dimensionality allows SUMM to be treated as just another position in the transformer sequence while serving a special pooling role. Inside multi-head self-attention, each position forms queries, keys, and values. The SUMM position forms its own query and attends over the keys/values of all positions (including itself). During training, the higher-level loss (e.g., contrastive/hinge or softmax) can be computed on the output at the SUMM position (the “higher-level” embedding). Gradients flow back into the higher-level encoder and into the SUMM vector itself. Because only embeddings are used (not raw tokens), this pooling learns to integrate lower-level semantics efficiently, without re-encoding text.

Accordingly, the resultant higher-level encoder 304 can fully utilize the available information of each message already in the lower-level embeddings 303a, 303b, 303c, without requiring a summary of the document or accessing the underlying tokens in all the passages.

In some embodiments, the inference pipeline of DHR (“Dense hierarchical retrieval for open-domain question answering”, Ye Liu, Kazuma Hashimoto, Yingbo Zhou, Semih Yavuz, Caiming Xiong, and Philip S Yu, arXiv preprint arXiv:2110.15439, 2021, incorporated by reference herein) may be used and modified for ESHR.

For example, the inference can comprise two main stages. First, all the retrieval documents (e.g., Wikipedia™ articles) can be encoded into a vector space. All the questions in the test set can then be encoded. In one exemplary example, the most similar documents can be selected according to the dot product similarity of the embeddings, using e.g., Facebook™ artificial intelligence similarity search (FAISS). For a fixed set of retrieval corpus and higher-level retriever, the inference time (comprising encoding queries and selecting top documents) according to the described embodiments can take the same time as DHR. However, because higher-level entities are encoded using their lower-level embeddings, the higher-level embedding stage can take longer than DHR.

In some embodiments, during inference, the higher-level retriever 308 is applied first (e.g., by applying the similarity function 312 to the higher-level embeddings generated by the higher-level encoder 306) to reduce the scope of higher-level text entities (e.g., documents) which are considered for answering the given query, before further locating the specific lower-level text entities (e.g., passages) using the lower-level retriever 306.

According to some embodiments of this disclosure, the lower-level encoder 302 may be trained in a standard way; and the higher-level encoder 304 is trained without assuming access to a summary for each document but by utilizing the lower-level embeddings 303a, 303b, 303c directly. The training process of the computer network system 100 is explained below.

Referring to FIG. 3, higher-level representations are calculated based on the representations of the lower-level text entities (e.g., passages). Therefore, to train the higher-level retriever 308, the lower-level retriever 306 is trained first. Then the higher-level retriever 308 is trained using the output from the lower-level encoder 302 on all the lower-level text entities (e.g., passages) in each higher-level text entity (e.g., document). In some embodiments, the lower-level retriever 306 can be trained using the dense passage retrieval (DPR) training (e.g., “Dense passage retrieval for open-domain question answering”, Vladimir Karpukhin, Barlas Oguz, Sewon Min, Patrick Lewis, Ledell Wu, Sergey Edunov, arXiv preprint arXiv:2004.04906, 2020, incorporated by reference herein). For efficiency, the lower-level retriever 306 and the higher-level retriever 308 can be trained stage-by-stage in some embodiments. That is, the lower-level retriever 306 can be fixed when training the higher-level retriever 308, while the output from the lower-level retriever 306 is used as input for the higher-level retriever 308.

In some embodiments, to train the lower-level retriever 306, both the query encoder 310 and lower-level encoder 302 are initialized with a pre-trained transformer model (e.g., bert-base-uncased). Further, to train the higher-level retriever 308, the query encoder 310 can be initialized with the pre-trained transformer model (e.g., bert-base-uncased). The higher-level encoder 304 and the trainable vector SUMM 307 may be initialized randomly. Note that the lower-level encoder 302 does not have any notion of the higher-level representation, as the lower-level retriever 306 in the bi-encoder model is only trained to distinguish a lower-level text entity (e.g., passage) between positive versus negative.

The goal for training the higher-level retriever 308 is to make the embedding of the query 311 closer to the embedding of the relevant (positive) higher-level entity (e.g., document)

$${d}_{q}^{*} ∈ D$$

than to any non-relevant (negative) higher-level entity

$${d}^{-} ∈ D ∖ \{ {d}_{q}^{*} \} .$$

In other words, the model is trained to satisfy the following inequality loss function:

$$M ( g ( q ) , f ( {d}_{q}^{*} ) ) > M ( g ( q ) , f ( {d}^{-} ) ) , ∀ {d}^{-} ∈ D ∖ \{ {d}_{q}^{*} \} . \qquad ( 2 )$$

where

$${d}_{q}^{*}$$

represents a relevant (positive) higher-level entity, and d⁻ represents a non-relevant (negative) higher-level entity. M (⋅,⋅) is a similarity function (e.g., dot product or cosine similarity). In other words, the model is trained to enforce that the similarity between the query embedding and the positive higher-level embedding exceeds the similarity to any negative higher-level embedding.

A loss function is a component of the machine learning model used to evaluate how well the model's predictions align with actual target values. It quantifies the difference between a predicted output and the ground truth, serving as a guide for optimizing model parameters during training.

According to some embodiments, the higher-level retriever 308 is optimized using a contrastive loss that incorporates one positive higher-level entity (e.g., document) and several negative higher-level entities, including one hard and multiple in-batch negative higher-level entities, for each query q:

$$ℒ ( q , {d}_{q}^{*} , {D}_{q}^{-} ) = - log \frac{{e}^{M ( g ( q ) f ( {d}_{q}^{*} ) )}}{{\sum }_{d ∈ \{ {d}_{q}^{*} \} ⋃ {D}_{q}^{-}} {e}^{M ( g ( q ) , f ( d ) )}} . \qquad ( 3 )$$

where

$${d}_{q}^{*}$$

represents the positive higher-level entity (e.g., the gold document) and D_{q}⁻ represents all the negative higher-level entities. In other words, the higher-level retriever 308 is trained that the embedding of the query 311 is closer to the embedding of the positive higher-level entity (e.g., document) than to any negative higher-level entity

$${d}^{-} ∈ {D}_{q}^{-} .$$

In the context of information retrieval models, a “gold document” or “gold passage” refers to the correct or most relevant document/passage for a given query or question. A hard negative may be one that is semantically or visually similar to the positive example but belongs to a different class; and an in-batch negative may be an example within the same training batch as a negative sample. Contrastive loss is designed to learn discriminative features by comparing pairs of samples and encouraging similar instances to be close together in the embedding space while pushing dissimilar instances apart.

In Equation (2), D refers to the entire corpus, but due to computational limitations, for the loss function,

$${D}_{q}^{-}$$

is used consisting of all the negative documents in the training batch.

In some embodiments, to generate a suitable dataset for training the higher-level retriever 308, each training sample includes a question as well as a corresponding positive document and multiple hard negative documents. In an exemplary example, the parent document of the gold passage p* is taken as the positive document d*. Further, in some embodiments, hard negative documents are curated according to a defined criteria to improve training efficacy.

In some embodiments, hard negatives can be obtained, using a procedure modified from “Dense hierarchical retrieval for open-domain question answering”, Ye Liu, Kazuma Hashimoto, Yingbo Zhou, Semih Yavuz, Caiming Xiong, and Philip S Yu., arXiv preprint arXiv:2110.15439, 202, incorporated by reference herein. For example, the hard negatives can be obtained during training by selecting based on the similarity of the question/query to the document abstracts and the content of other passages.

In particular, similar documents can be selected according to the similarity between the abstract and the question/query using Best Match 25 (BM25). However, in some embodiments, documents that contain any occurrence of the answer in their lower-level entities (e.g., passages) are excluded, without relying only on the labeled positive. This approach is used to maintain consistency with the baseline, and the negative sampling method can be replaced by other approaches if the abstract paragraph is not available.

The ESHR model has been evaluated on three well-known datasets: NaturalQuestions (NQ) which includes real Google™ search queries, CuratedTREC (TREC) which includes questions and answers from text retrieval conference (TREC) track, and TriviaQA which includes trivia questions scraped from web. Each dataset can be processed to generate suitable positive and negative documents as explained above.

For experiments, the higher-level encoder models can be trained with a learning rate (lr) of 8e-5, and the question encoders can be trained with a lr of 8e-6. Lr refers to a hyperparameter that determines the step size at each iteration while moving toward a minimum of a loss function. Linear scheduling can be used with warmup for the learning rate, and the model can be trained using two 40 GB A100 graphics processing units (GPUs) and with the batch size of 128. The higher-level encoder can take the first 256 passages of the document as input, and maximum number of tokens processed by the lower-level encoder and query encoders are 280 and 80 tokens, respectively. The model may be finetuned for 2800 epochs for TREC (i.e., a very small dataset), and for 40 epochs for NQ and TriviaQA datasets. The best checkpoint can be picked based on the top-20 performance on validation set using the positive and at most 30 hard negative documents.

The ESHR model is compared with DHR as the baseline. The performance of ESHR in Top-k (k∈{1, 5, 20, 100}) accuracy is reported. This metric can highlight how frequently the correct document appears in the top k retrieved documents. Since there is no annotated data for ground-truth documents of test sets, a document is considered correct, if a notion of the correct answer exists in one of the document's passages. A document retrieval model with higher Top-k accuracy can lead to better passage retrieval as well. The reason is that higher Top-k means that the correct document has been selected more often, and hence, the passages of the correct document are included in the passage retrieval corpus more often as well. The better the quality of passage retrieval corpus is, the better a fixed passage retrieval model can perform.

Table 1 shows the evaluation results of the described embodiments compared to the baseline. As can be seen in Table 1, the described embodiments outperform the baselines NQ and TriviaQA while getting competitive performance on TREC dataset. One potential reason for the TREC dataset results can be attributed to the size of the TREC dataset which limits the training quality of the described higher-level encoder.

TABLE 1

| | NaturalQuestions | | | | TREC | | | | TriviaQA | | | |
|---|---|---|---|---|---|---|---|---|---|---|---|---|
| Model | Top-1 | Top-5 | Top-20 | Top-100 | Top-1 | Top-5 | Top-20 | Top-100 | Top-1 | Top-5 | Top-20 | Top-100 |
| DHR 11 | 64.79 | 82.13 | 87.76 | 92.08 | 52.59 | 72.48 | 87.18 | 93.52 | 44.86 | 63.51 | 74.89 | 82.83 |
| Naive AVG | 18.86 | 40.97 | 60.78 | 78.01 | 26.22 | 54.03 | 75.36 | 88.62 | 27.13 | 49.57 | 65.98 | 79.83 |
| ESHR | 66.80 | 82.49 | 88.98 | 92.38 | 51.59 | 75.94 | 86.46 | 94.09 | 55.67 | 73.18 | 81.38 | 86.69 |

The ablation study on NaturalQuestions dataset is also evaluated as shown in Table 2. While a simple average over the lower-level embeddings serves as an intuitive solution, the experiments indicate that this approach (referred to as “Naïve Average (AVG)”) leads to significant information loss and reduced embedding quality, as the documents include detailed and distracting information in some passages. Especially in long documents, it is more probable for the passages to be detailed.

TABLE 2

| Model | Top-1 | Top-5 | Top-20 | Top-100 |
|---|---|---|---|---|
| ESHR | 66.80 | 82.49 | 88.98 | 92.38 |
| ESHR - JT | 63.55 | 81.11 | 88.01 | 91.88 |
| ESHR - JT - PN | 62.30 | 80.75 | 87.73 | 91.80 |
| Weighted AVG | 43.93 | 69.58 | 81.02 | 89.34 |
| Naive AVG | 18.86 | 40.94 | 60.80 | 78.01 |

Experiments using weighted average of the passages embeddings as the document representation (referred to as “Weighted AVG”) are conducted, where the weights are determined by a transformer-based scorer model taking the passage embeddings as input. For the Weighted AVG model, a light-weight transformer-based scorer model is used to assign weights to the document's passages. In other words, the representation of the document d={p₁, p₂, . . . , p_{M}} will be calculated as:

$${s}_{1} , {s}_{2} , … , {s}_{M} = Sc orer ( {p}_{1} , {p}_{2} , … , {p}_{M} ) , \qquad ( 4 )$$

$$f ( d ) = {s}_{1} {f}_{p} ( {p}_{1} ) + {s}_{2} {f}_{p} ( {p}_{2} ) , … , {s}_{M} {f}_{p} ( {p}_{M} ) , \qquad ( 5 )$$

where fₚ is the trained passage encoder, and sᵢ is the normalized score assigned to passage pᵢ. The scorer model is a 2-layer transformer model followed by a single linear layer to transform the d-dimensional representation of each passage to a scalar. The score sᵢ for passage pᵢ in Equation (5) is calculated as follows.

$$( {O}_{{p}_{1}} , {O}_{{p}_{M}} ) = Linear ( Transformer ( {f}_{P} ( {p}_{1} ) , … , {f}_{P} ( {p}_{M} ) ) ) , \qquad ( 6 )$$

$${s}_{i} = \frac{{e}^{{o}_{{p}_{i}}}}{{\sum }_{r = 1}^{M} {e}^{{o}_{{p}_{r}}}} . \qquad ( 7 )$$

This model can be randomly initialized and trained with learning rate of 2e-4 and batch size 128 for 40 epochs with the same loss function in Equation (3). Although the performance boosts compared to Naïve Average (AVG), it still falls short of more complicated scenarios.

Furthermore, mining better hard negative documents for questions can result in better training and higher performance at inference. In Table 2 the hard negative document mining (referred to as “ESHR-JT-PN”) is tested exactly as implemented in DHR codebase, where the hard negative documents of a question are simply the ones that are similar to the question but not the same as the labeled positive. Accordingly, a document can be annotated as negative even when relevant to the context. In contrast, in ESHR precise negatives are used in some embodiments, where it is additionally checked whether the text explicitly includes the question's answer or not.

The effectiveness of jointly training the query encoder is also tested, compared with fixing the query encoder as the one learned for lower-level retrieval. In the ESHR-JT mode as an ablation, the query encoder is initialized with the pretrained DHR passage retriever's query encoder. Since the query encoder is already trained, this mode does not finetune the model anymore.

Referring to FIG. 3, during each iteration of the training, when a query 305 and a high-level entity (e.g., comprising lower-level entities 301a, 301b, 301c) are passed through the model, the loss function can be calculated based on the obtained higher-level embedding 309 and the query embedding 311. The loss function can then be backpropagated to the higher-level encoder 304, the question encoder 310, the trainable vector 307, and/or the lower-level encoder 302 to train the various components of the system. The experiments compare results between a model that stops the back propagation before the question encoder 310 and a model that trains the question encoder 310 together with the higher-level encoder 304.

Although in some embodiments the lower-level encoder is realized through a pre-trained model due to memory constraints, it should be understood that the lower-level encoder can be trained independently or even jointly with other components as explained above.

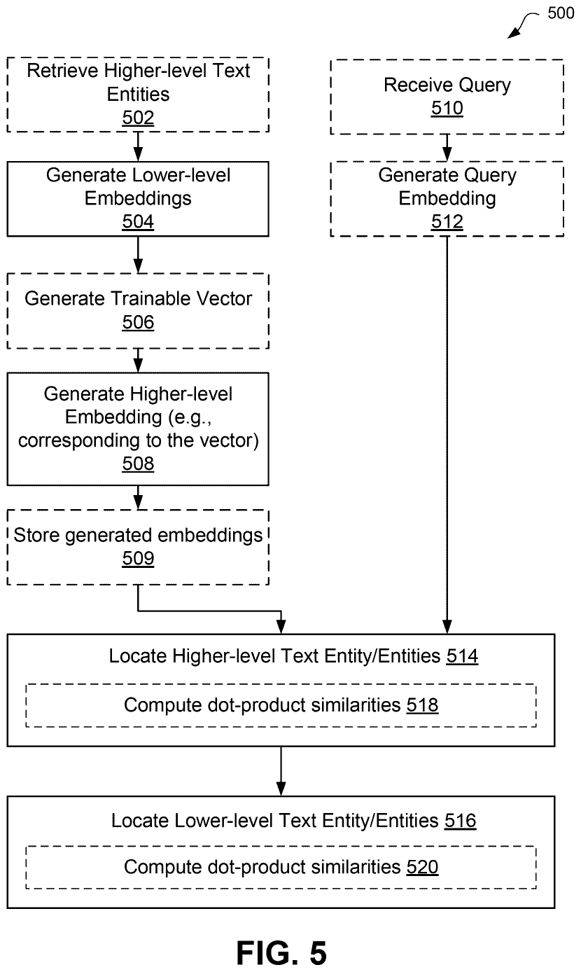

FIG. 5 is a flowchart showing operations of a method (500) of a computerized method of hierarchical information retrieval amongst a corpus of higher-level text entities, according to some embodiments of this disclosure.

The method (500) may start at operation (502) where higher-level text entities are retrieved and used for encoding. The method comprises, for each of the higher-level text entity in the corpus, generating (504), by a lower-level neural-network-based encoder, a plurality of lower-level embeddings for a plurality of lower-level text entities respectively representing a plurality of lower-level text entities within the higher-level text entity; and generating (508), by a higher-level neural-network-based encoder, a higher-level embedding of the higher-level text entity based on the plurality of lower-level embeddings of the plurality of the lower-level text entities.

As described above, the plurality of lower-level embeddings and the higher-level embedding may have a same dimensionality. In some embodiments, the plurality of lower-level embeddings and the higher-level embedding generated for each higher-level text entity may be stored (509) in a database prior to receiving the query.

In some embodiments, the method can further comprise generating (506) a vector SUMM co-dimensional with the plurality of lower-level embeddings of the plurality of the lower-level text entities. As described, the vector SUMM is trainable to summarize among the plurality of lower-level embeddings. The higher-level embedding is generated as an output corresponding to the trainable vector. In some embodiments, the trainable vector SUMM may be initialized randomly. The vector SUMM can then be trained during training, and remains fixed during inference for all higher-level text entities. In some embodiments, vector SUMM can be jointly trained with parameters of the higher-level neural-network-based encoder.

Subsequent or concurrent to the generation of lower-level and higher-level embeddings, the method further comprises receiving (510) a query; and generating (512) an embedding of the query.

The method can produce outputs based on locating (514) one or more higher-level text entities corresponding to one or more higher-level embeddings which have the highest similarities to the embedding of the query. In some embodiments, a plurality of higher-level text entities may be located corresponding to top-k higher-level embeddings similar to the embedding of the query. The method can further locate (516) one or more lower-level text entities corresponding to the one or more lower-level embeddings which have the highest similarities to the embedding of the query. In some embodiments, said locating one or more lower-level text entities corresponding to one or more lower-level embeddings comprises locating one or more lower-level text entities from within the located higher-level text entities.

In some embodiments, the lower-level neural-network-based encoder, the higher-level neural-network-based encoder, and the query encoder each comprise a transformer-based model.

In some embodiments, locating the one or more higher-level text entities comprises computing (518) dot-product similarities between higher-level embeddings and the query embedding and returning a first top-k set of higher-level text entities; and locating the one or more lower-level text entities comprises computing (520) dot-product similarities between lower-level embeddings and the query embedding and returning a second top-k set of lower-level text entities.

In some embodiments, the lower-level neural network encoder is trained prior to training the higher-level neural network encoder, and the higher-level neural network encoder is trained using the plurality of lower-level embeddings as input.

In some embodiments, training the higher-level neural-network-based encoder comprises optimizing a contrastive loss that increases similarity between the query embedding and a positive higher-level text entity while decreasing similarity relative to one or more negative higher-level text entities.

In some embodiments, the one or more negative higher-level text entities include at least one hard negative higher-level text entity and a plurality of in-batch negative higher-level text entities.

In some embodiments, the at least one hard negative higher-level text entity is obtained by excluding higher-level text entities that contain an occurrence of an answer to the query within any of their lower-level text entities.

The described systems, methods, apparatuses, and computer readable medium provide an ESHR framework to learn different levels of embeddings that can be used in hierarchical retrieval, where the higher-level (e.g., document) embeddings are synthesized from the lower-level (e.g., passage) embeddings through a learnable function. The methods, systems, and techniques disclosed herein not only can facilitate the handling of long documents but also can be generalized naturally to more complex and intricate text hierarchies, which may help to locate the relevant information more accurately, in contrast to the existing methods.

According to various embodiments, the lower-level text entities (e.g., passages) of a higher-level text entity (e.g., document) are processed by a lower-level encoder (e.g., passage encoder) to produce their embeddings, which are subsequently consumed by the higher-level encoder (e.g., document encoder) to produce the embedding for the higher-level text entity. A new learnable vector SUMM is introduced to pool across the lower-level embeddings to “summarize” the higher-level text entity. The described methods and systems employ one or more transformer-based neural networks for the lower-level encoder, higher-level encoder, and the question encoder, where the lower-level encoder, higher-level encoder, the learnable vector SUMM, and the higher-level encoder can be trained. The methods and systems described produce the relevant higher-level text entity (e.g., document) as the one whose embedding has the highest similarity to the question embedding.

The described methods and systems are simple, intuitive, and effective. The described embodiments show better or competitive performance while having wider applicability compared to the conventional hierarchical retrieval baseline, which requires the summaries written by humans to generate their embeddings. The method is evaluated on NaturalQuestions, TriviaQA, and CuratedTREC datasets, showing that it performs better or competitively compared to existing techniques in terms of retrieval accuracies.

The disclosed methods and systems can improve the functioning of computer systems by transforming expensive token-level processing into lightweight vector operations, thereby reducing memory bandwidth, central processing unit (CPU)/GPU cycles, and latency at query time. By precomputing and storing both lower-level and higher-level embeddings separately (e.g., offline), the system avoids repeated tokenization and model inference over raw text, enabling retrieval via constant-time similarity computations over compact, fixed-dimension vectors rather than full-text scanning. The hierarchical, two-stage retrieval (document-then-passage) further decreases input/output operations and intermediate data movement by narrowing the search space early, which improves cache locality and reduces contention on accelerators. The trainable pooling vector (SUMM) allows the higher-level encoder to synthesize document representations directly from passage embeddings without re-accessing tokens, yielding a deterministic, bounded compute and memory profile per query. Collectively, these architectural choices increase throughput, lower tail latency under concurrent load, and enable scalable deployment on constrained hardware (including edge or on-premise environments) by decoupling heavyweight encoding from lightweight serving.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the invention and is not intended to limit the scope of the invention unless otherwise claimed.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computerized method of hierarchical information retrieval amongst a corpus of higher-level text entities, comprising:
for each of the higher-level text entity in the corpus:
generating, by a lower-level neural-network-based encoder, a plurality of lower-level embeddings respectively representing a plurality of lower-level text entities within the higher-level text entity; and
generating, by a higher-level neural-network-based encoder, a higher-level embedding of the higher-level text entity based on the plurality of lower-level embeddings;
receiving a query;
generating an embedding of the query;
locating one or more higher-level text entities corresponding to one or more higher-level embeddings which have the highest similarities to the embedding of the query; and
locating one or more lower-level text entities corresponding to one or more lower-level embeddings which have the highest similarities to the embedding of the query.

2. The computerized method of claim 1, further comprises:
generating a vector co-dimensional with the plurality of lower-level embeddings to summarize among the plurality of lower-level embeddings; and
wherein generating the higher-level embedding of the higher-level text entity comprises generating the higher-level embedding as an output corresponding to the vector.

3. The computerized method of claim 2, wherein the vector is initialized randomly and jointly trained with parameters of the higher-level neural-network-based encoder.

4. The computerized method of claim 3, wherein the vector remains fixed during inference for all higher-level text entities.

5. The computerized method of claim 1, wherein the lower-level neural-network-based encoder, the higher-level neural-network-based encoder, and the query encoder each comprise a transformer-based model.

6. The computerized method of claim 1, wherein the plurality of lower-level embeddings and the higher-level embedding have a same dimensionality.

7. The computerized method of claim 1, wherein further comprising storing, in a database, the plurality of lower-level embeddings and the higher-level embedding generated for each higher-level text entity prior to receiving the query.

8. The computerized method of claim 1, wherein locating the one or more higher-level text entities comprises computing dot-product similarities between higher-level embeddings and the query embedding and returning a first top-k set of higher-level text entities; and locating the one or more lower-level text entities comprises computing dot-product similarities between lower-level embeddings and the query embedding and returning a second top-k set of lower-level text entities.

9. The computerized method of claim 1, wherein said locating one or more lower-level text entities corresponding to one or more lower-level embeddings comprises locating one or more lower-level text entities from within the located one or more higher-level text entities.

10. The computerized method of claim 1, wherein the lower-level neural network encoder is trained prior to training the higher-level neural network encoder, and wherein the higher-level neural network encoder is trained using the plurality of lower-level embeddings as input.

11. The computerized method of claim 10, wherein training the higher-level neural-network-based encoder comprises optimizing a contrastive loss that increases similarity between the query embedding and a positive higher-level text entity while decreasing similarity relative to one or more negative higher-level text entities.

12. The computerized method of claim 11, wherein the one or more negative higher-level text entities include at least one hard negative higher-level text entity and a plurality of in-batch negative higher-level text entities.

13. The computerized method of claim 11, wherein the at least one hard negative higher-level text entity is obtained by excluding a higher-level text entity that contains an occurrence of an answer to the query within the corresponding lower-level text entities.

14. One or more processors for performing actions comprising:
for each of the higher-level text entity in the corpus:
generating, by a lower-level neural-network-based encoder, a plurality of lower-level embeddings respectively representing a plurality of lower-level text entities within the higher-level text entity; and
generating, by a higher-level neural-network-based encoder, a higher-level embedding of the higher-level text entity based on the plurality of lower-level embeddings;
receiving a query;
generating an embedding of the query;
locating one or more higher-level text entities corresponding to one or more higher-level embeddings which have the highest similarities to the embedding of the query; and
locating one or more lower-level text entities corresponding to one or more lower-level embeddings which have the highest similarities to the embedding of the query.

15. The one or more processors according to claim 14, wherein the actions further comprise:
generating a vector co-dimensional with the plurality of lower-level embeddings to summarize among the plurality of lower-level embeddings; and
wherein generating the higher-level embedding of the higher-level text entity comprises generating the higher-level embedding as an output corresponding to the vector.

16. The one or more processors according to claim 14, wherein the plurality of lower-level embeddings and the higher-level embedding have a same dimensionality.

17. The one or more processors according to claim 14, wherein the actions further comprise storing, in a database, the plurality of lower-level embeddings and the higher-level embedding generated for each higher-level text entity prior to receiving the query.

18. One or more non-transitory computer-readable storage media comprising computer-executable instructions, wherein the instructions, when executed, cause one or more processors to perform actions comprising:
for each of the higher-level text entity in the corpus:
generating, by a lower-level neural-network-based encoder, a plurality of lower-level embeddings respectively representing a plurality of lower-level text entities within the higher-level text entity; and
generating, by a higher-level neural-network-based encoder, a higher-level embedding of the higher-level text entity based on the plurality of lower-level embeddings;
receiving a query;
generating an embedding of the query;
locating one or more higher-level text entities corresponding to one or more higher-level embeddings which have the highest similarities to the embedding of the query; and
locating one or more lower-level text entities corresponding to one or more lower-level embeddings which have the highest similarities to the embedding of the query.

19. The one or more non-transitory computer-readable storage media according to claim 18, wherein the actions further comprise:
generating a vector co-dimensional with the plurality of lower-level embeddings to summarize among the plurality of lower-level embeddings; and
wherein generating the higher-level embedding of the higher-level text entity comprises generating the higher-level embedding as an output corresponding to the vector.

20. The one or more non-transitory computer-readable storage media according to claim 18, wherein the plurality of lower-level embeddings and the higher-level embedding have a same dimensionality.
